(19) United States
(12) Patent Application Publication
(10) Pub. No.: US 2015/0066568 A1
(43) Pub. Date: Mar. 5, 2015

(54) SERVICE AND LOCATION SELECTION IN THE CLOUD

(71) Applicant: Adobe Systems Incorporated, San Jose, CA (US)

(72) Inventor: David Rees, San Jose, CA (US)

(73) Assignee: Adobe Systems Incorporated, San Jose, CA (US)

(21) Appl. No.: 14/016,853

(22) Filed: Sep. 3, 2013

(51) Int. Cl. G06Q 10/06

(52) U.S. Cl. CPC G06Q 10/06315
USPC 705/7.25

(57) ABSTRACT

Techniques are disclosed for selecting one or more services and locations for performing a user-requested operation on a file. A user interface can be used to search for files by name, date, content, location, and/or other parameters. The search results can be derived from information stored in a local cache and presented as a list from which the user can select files and perform operations on the selection. The cache can include historical information about each service and location, including a previously observed monetary cost to perform the operation and/or a previously observed amount of time used to perform the operation. A weighted value associated with any given service can be computed based on the historical information in the local cache, the age of the historical information and a cost criterion. The list of services can be ordered by the weighted value.

### FIELD OF THE DISCLOSURE

This disclosure relates to data processing, and more particularly, to techniques for selecting services and locations in the cloud for performing operations on files.

### BACKGROUND

The advent of low-cost, high-performance network communication infrastructures, such as the Internet, is enabling many computing operations to be performed beyond the confines of the personal computer (PC). With cloud computing, files and applications that once were stored and executed locally on a PC can now be hosted as services on remote systems. However, as a result, these files and applications can become fragmented across various devices and systems, making data management in the cloud significantly more complex than in the PC domain. Furthermore, some clouds have different data organization conventions, different user interfaces, and different means for accessing data and services. It can be difficult to manage multiple versions of data stored in different locations, and also difficult to identify cost-effective cloud-based services for performing operations on the data.

### BRIEF DESCRIPTION OF THE DRAWINGS

FIG. 1 illustrates an example cloud computing environment configured in accordance with an embodiment of the present invention.

FIG. 2 illustrates an example user computing system configured in accordance with an embodiment of the present invention.

FIG. 3 illustrates an example of historical information stored in a cache, in accordance with an embodiment of the present invention.

FIG. 4 illustrates an example methodology for generating a list of services and locations, in accordance with an embodiment of the present invention.

FIGS. 5a and 5b illustrate an example methodology for computing a weighted value of a service, in accordance with an embodiment of the present invention.

FIG. 6 illustrates an example user interface configured in accordance with an embodiment of the present invention.

### DETAILED DESCRIPTION

Various embodiments are directed to techniques for selecting services and locations in the cloud for performing user-requested operations on a file. In some instances, the file may be stored in the same location that the service exists, while in other instances the file and service may at least initially be in different locations. A user interface can be used to search for files by name, date, content, location, and/or other parameters. The search results can be derived from information stored in a local cache and presented as a list from which the user can select files and perform operations on the selection. The cache can include, among other things, historical information about various services and locations, such as monetary costs to perform the operation and/or amounts of time taken to perform the operation. In conjunction with the search, the user can specify a cost criterion that prioritizes aspects such as cost, time, and other factors relating to the use of the services at the various locations. A weighted value associated with a given service can be computed based on the historical information in the local cache, the age of the historical information and the cost criterion. In the search results, the list of services and locations can be ordered by the weighted values, and the user may select files and services from the list to perform the operation. Numerous configurations and variations will be apparent in light of this disclosure.

General Overview

As used herein, a cloud refers to any client-server architecture in which at least some computation and/or data storage is relocated from a client computing system to one or more remote servers that provide the computation or data storage as a commodity or utility. A cloud may, for example, include a large collection of resources that can be interchangeably provisioned and shared among many clients. For example, copies of a file may be stored locally and/or remotely in one or more clouds. Since each cloud can have different file organization conventions, user interfaces, or means to access files, it can be difficult for a user to determine whether multiple copies or versions of a file exist, where such copies exist and whether each copy is current or outdated. In some cases, performing an operation upon one or more files in the cloud can involve multiple steps. For example, if the file is stored locally and the desired service resides in the cloud, then the file may need to be moved to the same location as the service in the cloud prior to performing the operation. Further, different clouds and services can have different monetary costs or processing times associated with their use that are not readily comparable by the user.

Thus, and in accordance with at least one embodiment of the present invention, a user interface (UI) can be configured to search for files stored in one or more locations, for example, locally and remotely in the cloud, and services for performing operations on the files. The search results can be derived from a local cache populated with historical information relating to files, services, and locations in the cloud. The search results can be presented in a consistent form, for instance, as a list of file names, file content, or metadata, and ordered according to various factors including the age of the historical information in the cache and certain user-specified cost criteria, such as the monetary cost or time associated with performing various operations on the files. Examples of file operations include delete, synchronize, edit, compare, convert type, optical character recognition (OCR), and reformat. The user can select one or more files from the list and perform one or more operations on the selected files. The UI can be further configured to identify where files are located, and where they need to be to perform an operation. In this manner, a user can quickly find, organize, and perform operations on files regardless of the locations of the files and services. In some embodiments, scripts can be used to allow multiple operations to be performed in sequence, for instance, by different services and/or at different locations.

System Architecture

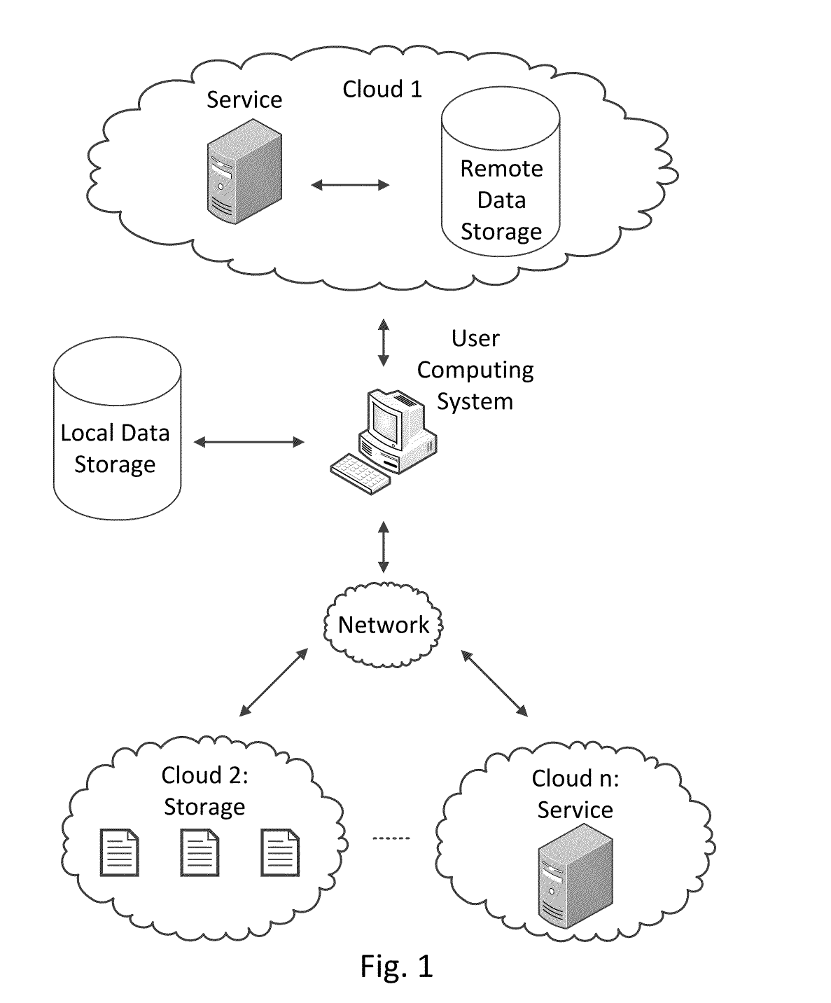

FIG. 1 illustrates an example cloud computing environment configured in accordance with an embodiment of the present invention. A user computing system, such as a personal computer (PC), is operatively connected to one or more other local data storage devices, services, remote data storage devices, and clouds, either directly or via network connections, such as the Internet. Through these various connections, the user computing system can access data and services that reside in different locations or so-called clouds. The data storage devices can be implemented, for example, with any suitable type of memory, such as a disk drive included in, or otherwise in communication with, the user computing system, the servers and/or the clouds. Other suitable memories include flash memory, random access memory (RAM), a memory stick or thumb drive, USB drive, cloud storage service, etc. In a more general sense, any memory facility can be used to implement the data storage. The services, clouds, and local and remote data storage devices can be configured to store files, execute applications and/or perform other functions at various locations, which are accessible by the user computing system.

It will be appreciated that, in some embodiments, various functions performed by the user computing system, services, clouds, and local and remote storage devices, as described herein, can performed by similar processors and/or databases in different configurations and arrangements, and that the depicted embodiments are not intended to be limiting. Various components of this example embodiment can be integrated into, for example, one or more desktop or laptop computers, workstations, tablets, smartphones, file servers, or other such computing devices. Other componentry and modules typical of a computing system, such as processors (e.g., central processing unit and co-processor, graphics processor, etc.), input devices (e.g., keyboard, mouse, touch pad, touch screen, etc.), output devices (e.g., displays, printers, speakers, etc.), and operating system, are not shown but will be readily apparent.

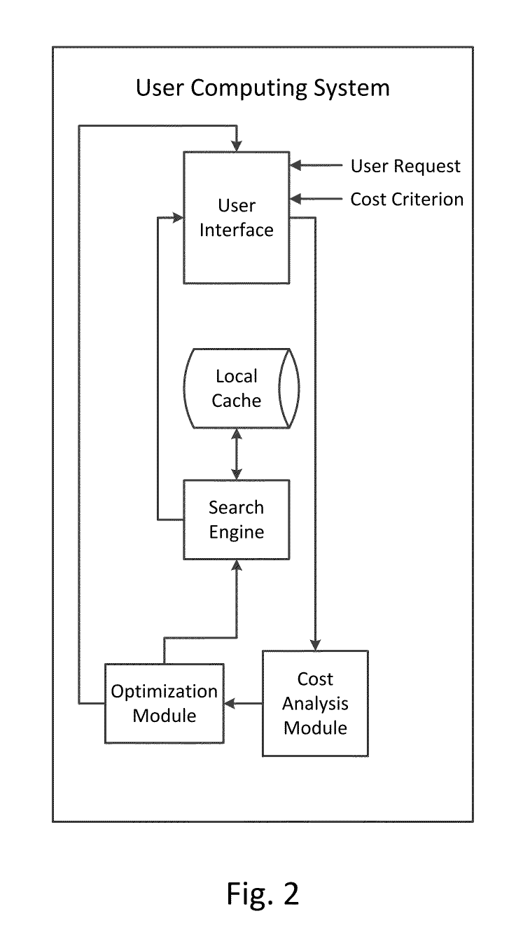

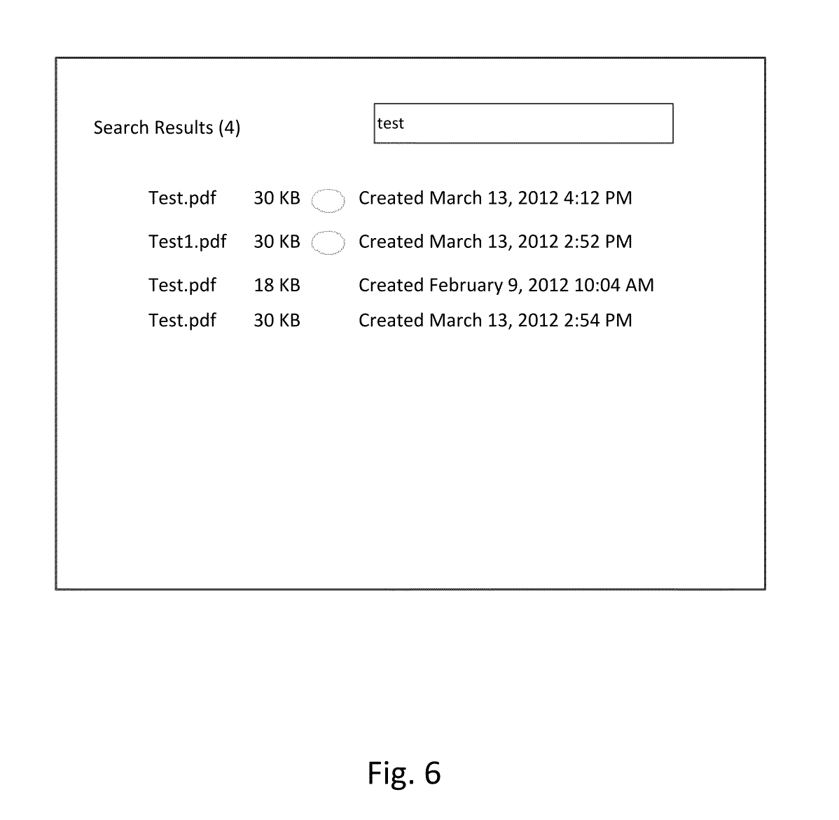

FIG. 2 illustrates an example user computing system, such as shown in FIG. 1, configured in accordance with an embodiment of the present invention. The user computing system includes a user interface, a local storage (also referred to as a local cache), a search engine, a cost analysis module and an optimization module. An example embodiment of the user interface is shown in FIG. 6 and described in further detail below. The search engine can be configured to receive a search query or other user request, via the user interface, and to perform a search for information stored in the local cache based on the search query or user request. One benefit of using the local cache, as opposed to other locations, such as the cloud, is to reduce the amount of time required to perform the search. The local cache can be populated with historical information about data (e.g., file names, content, metadata, etc.), services (e.g., for performing operations on the data), and their respective locations (e.g., locally or in the cloud). Such historical information can include monetary costs of performing various operations and/or time to perform the operations by each service at each location. In some cases, the information in the local cache may be refreshed over a period of time; therefore not all of the information used for the search may be current. The age of any piece of information in the local cache represents the amount of time that has elapsed since that piece of information was updated. Thus, one consequence of using the local cache is that some of the search results may be out of date if the information is not current. Although in this example the search engine is depicted as being included in the user computing system, it will be understood that the search engine may be included in a different computing device or system or distributed across several such devices or systems.

The user computing device can receive a user-specified cost criterion established by a user. The cost criterion defines the method by which the user wishes to compute the cost of performing the operation on the data set. For example, the user may wish to prioritize the speed at which the operation is performed over the monetary cost of performing the operation, or vice versa. The cost analysis module is configured to calculate a cost (monetary cost and/or time cost) of associated with satisfying the user request in a manner that meets the cost criterion, which is used by the optimization module to order the search results presented to the user via the user interface, as well as to prompt the search engine to refresh the historical information in the local cache.

Example of Information Stored in a Cache

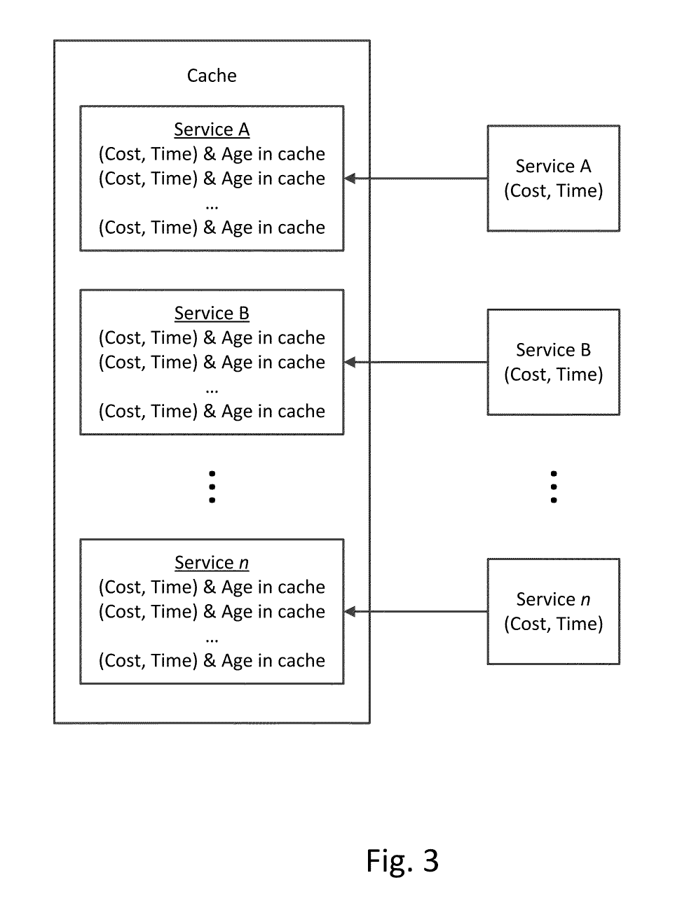

FIG. 3 illustrates one example of historical information stored in a cache, such as the local cache of FIG. 2, in accordance with an embodiment. In a given data processing environment, such as depicted in FIGS. 1 and 2, there can be any number of services, indicated in FIG. 3 as Service A and Service B through Service n. These services include data storage services and/or application services, and each service may reside at any one of several locations within the cloud-computing environment, for example, on a local computing system, a remote server, or in a cloud. For example, Service A may include an application to convert a Microsoft Word® document into a Portable Document Format (PDF) document (among other types of operations); Services B and C may each include a notarization service for notarizing PDF documents (among other types of data); and Service D may include a file storage service for storing notarized PDF documents (among other types of data).

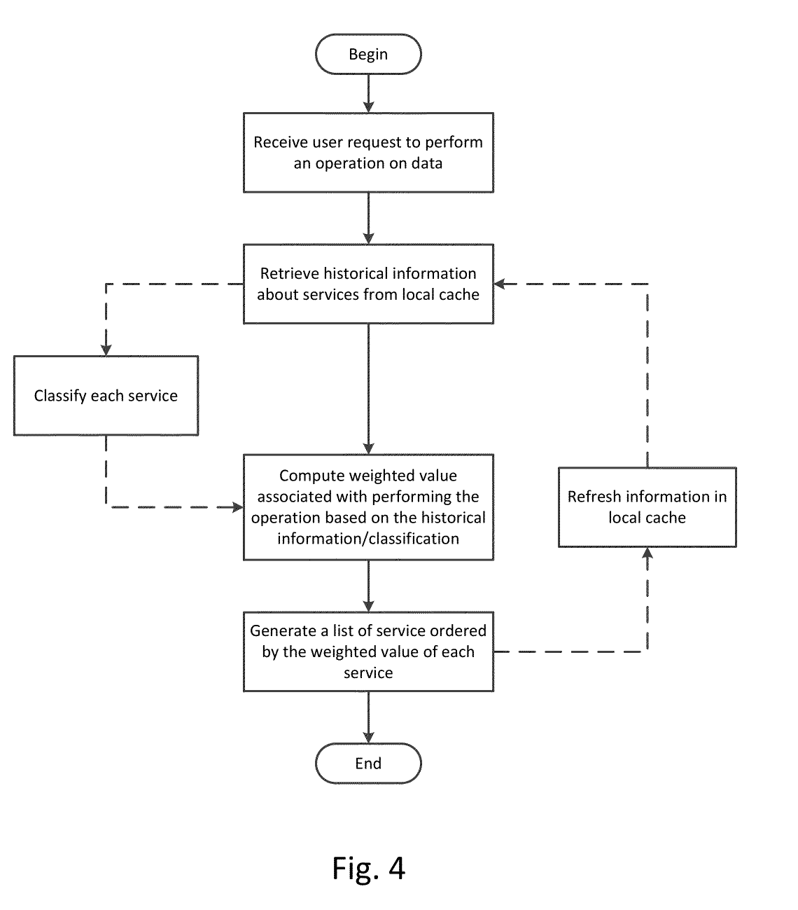

Associated with each service is a monetary cost of performing an operation by the service and/or an amount of time to perform the operation by the service. For example, the monetary cost of notarizing a document may be $5.00 for Service B and $4.90 for Service C, and the amount of time to notarize a document may be two hours for Service B and one hour for Service C. The monetary cost and/or time to perform an operation by any service is the actual monetary cost or time observed at a particular point in time—this forms a portion of the historical information about each service, which is stored in the cache. For instance, the above-described monetary cost and time for Service B may have been observed two hours ago, while the same information for Service C may have been observed three days ago. Thus, each piece of historical information in the cache also has an age associated with it. In general, older historical information is considered less accurate than relatively current historical information, since the monetary cost and time to perform the operation may change over time. The historical information for each service, as stored in the cache, can be used to compute a weighted value associated with performing a user-requested operation on a data set on each service that is capable of performing the operation, such as described below with respect to FIG. 4. The weighted values can be used to order a list of services, such that services having the lowest weighted value, or lowest cost (e.g., lowest monetary cost and/or time cost), appear higher in the list than services having higher weighted values. From the list, the user may select any one of the services to perform the desired operation. In some cases, more than one piece of historical information about any given service can be stored in the cache. For example, over a period of time Service B may have performed the same operation several times. Each time the operation is performed by Service B, historical information (e.g., the monetary cost and/or the time) can be stored in the cache. In this manner, a more complete historical profile of the monetary cost and/or time can be obtained for the service(s).

Example Methodology

FIG. 4 illustrates an example methodology configured in accordance with an embodiment. This method may be implemented, for example, by the user computing system, as shown in FIG. 2. It will be appreciated that the methodologies specifically described herein may vary from one embodiment to another, but when considered in the aggregate, form or otherwise provide a complete methodology for selecting a service or location in a cloud computing environment.

The method begins with receiving a user request to perform one or more operations on one or more files or sets of data. The user request may, for instance, be received via a user interface, such as described below with respect to FIG. 6, in which a list of files is displayed to the user in response to a search query. The user may use such a user interface to select one or more files and request one or more operations to be performed on the selected files. Examples of operations include open, copy, edit, delete, merge, synchronize, and convert, as well as other file operations that will be apparent in light of this disclosure. In some cases, the user request may specify a sequence of operations (e.g., merge a first file into a second file, and then delete the first file). To continue the above example of FIG. 3, suppose a user requests the following sequence of operations: 1) convert a Word document into a PDF document; 2) notarize the PDF document; and 3) save the notarized document in a cloud-based data store.

The method continues with retrieving historical information about a plurality of services each capable of performing the user-requested operation(s). The computing resources include, without limitation, local data storage resources, remote or cloud-based data storage resources, and services capable of performing the operation or operations in the user request. In some instances, more than one service may be capable of performing the same operation(s). The information is obtained from a local storage or cache, and therefore may not be current in part or in whole. In some cases, at least portions of the information in the local cache are incrementally refreshed over time by, for example, a background process, and/or portions of the information are refreshed in response to a search query.

To continue with the above example of FIG. 3, the historical information for Service B may include the monetary cost of notarizing a document of $5.00 and a time of two hours, and the historical information for Service C may include the monetary cost of $4.95 and time of one hour. Since in this example there is only one service (Service A) for converting the Word document to a PDF document, and only one service (Service D) for storing the notarized document, the user will only have a choice of selecting Service B or Service C for notarizing the PDF document. Further presume, in this example, that the historical information for Service B is older than the historical information for Service C.

In some cases, the method continues by classifying each service by type. For example, each service may be classified as a data store or an application. It will be understood that such classification is not necessarily performed in all embodiments. The method continues by computing a weighted value associated with performing the user-requested operation based on the historical information, an age of the historical information, and a user-specified cost criterion. With respect to the age of the information in the local cache, older information is more likely to be inaccurate (e.g., the monetary cost and/or time to perform the operation may have changed since the historical information was obtained). Accordingly, older information may be given less weight than newer information in the computation of the weighted value. The user-specified cost criterion can represent a relative importance of the monetary cost of performing the operation with respect to the amount of time to perform the operation. In other words, the user may specify whether monetary cost is more important than time, whether time is more important than monetary cost, or whether both are equally important. To continue with the example of FIG. 3, first presume that the historical information regarding the amount of time to perform the operation for Service B is given a weight of 1.0, since it is older than the historical information for Service C, which is given a weight of 0.9. Further presume that the monetary cost to perform the operation for Service B is given a weight of 0.8 as this information is relatively recent information, and the monetary cost to perform the operation for Service C is given a weight of 0.9 as this information is not current. Therefore, the computed weighted value for Service B is (time=2 hrs.)*(weight=1.0)+(cost=$5.00)*(weight=0.8)=6, and the computed weighted value for Service C is (time=1 hr.)*(weight=0.9)+(cost=$4.90)*(weight=0.9)=5.31.

The method continues by generating a list of the services ordered by the weighted value of each service. For example, the list may order the services according to the services that are the least expensive monetarily or the fastest in terms of processing time, depending on the user-specified cost criterion. To continue with the above example, if the user-specified cost criterion places equal importance on both monetary cost and time, then Service C (with a weighted value of 5.31) will be listed before Service B (with a weighted value of 6). However, if the user-specified cost criterion places more importance on monetary cost than time, the result changes: the computed weighted value for Service B becomes (cost=$5.00)*(weight=0.8)=4 and, for Service C, (cost=$4.90)*(weight=0.9)=4.41. Thus, in this instance, Service B will be listed before Service C. In this manner, the methodology described herein generates a list ordering the services based on how current the historical information is, and as such the result is more likely to incorporate the most current and, therefore, most accurate data. In the case where the computing resource is classified, the cost is further computed by class, that is, the cost is computed separately for each classification type (e.g., data store or application).

In some cases, the result can be used to refresh the information in the local cache (i.e., to reduce the staleness of the information). For instance, if one or more pieces of the information in the local cache are older, or more stale, than any other piece of information, the older pieces of historical information are refreshed with more current information about the respective service. The method may further obtain the refreshed information and compute the weighted value based on the refreshed information in an iterative manner, progressively guiding the result by older information and cost criteria that can then be used to retrieve current information more efficiently and refine the result until the information in the local cache produces the result having the lowest cost among all possible results.

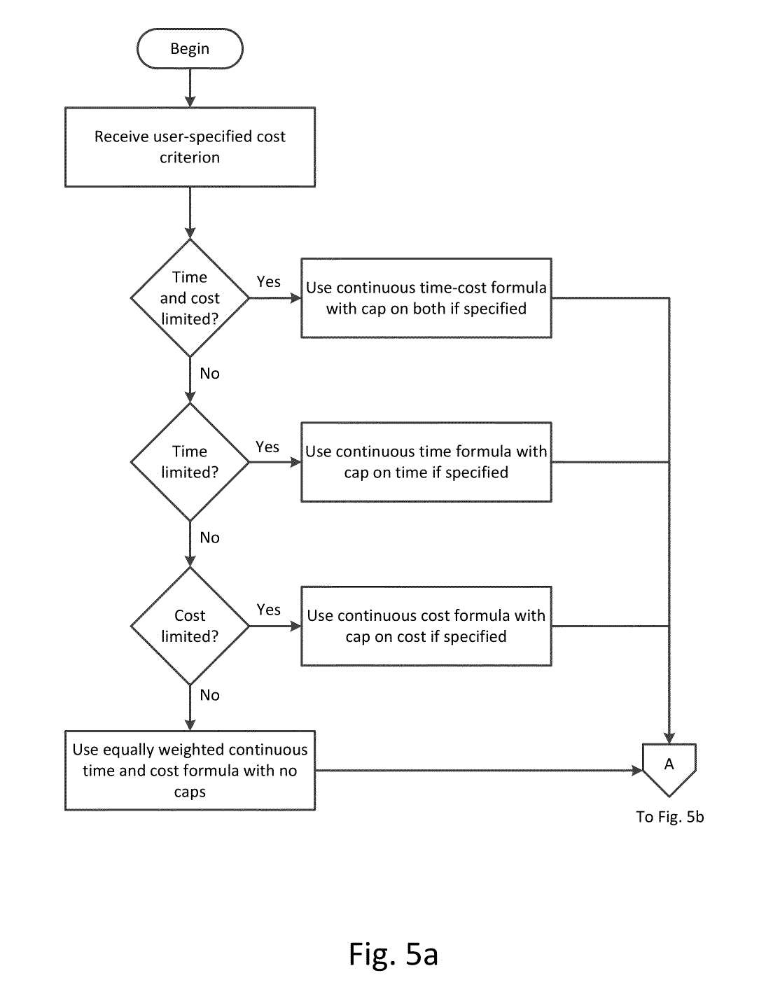

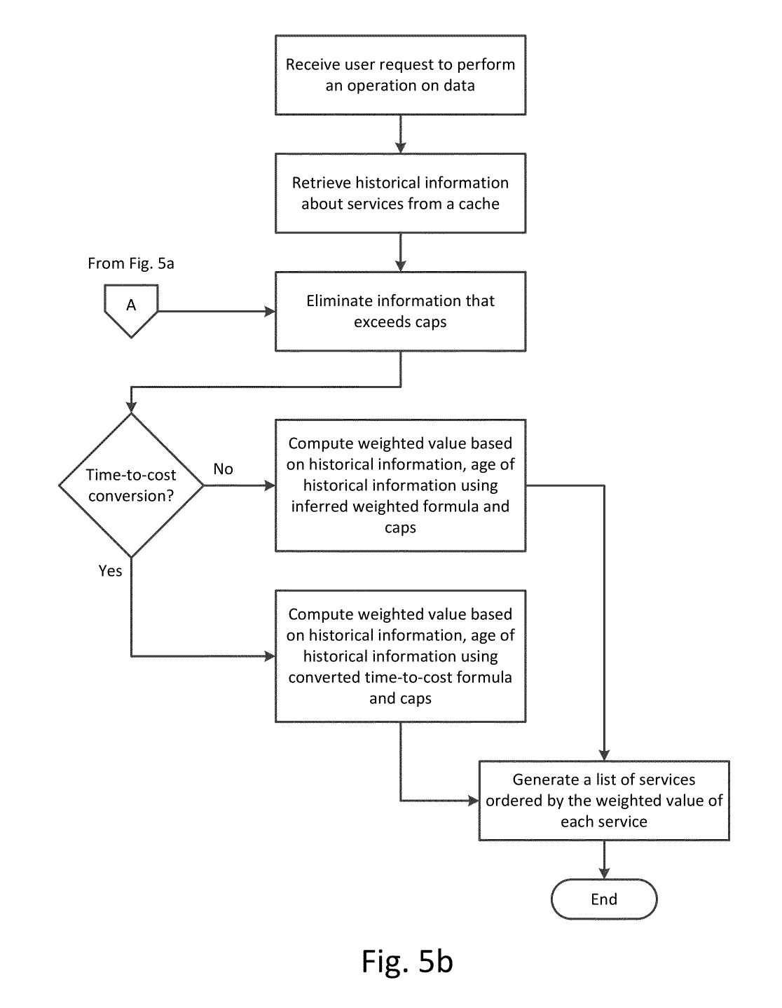

FIGS. 5a and 5b illustrate in further detail an example methodology for, among other things, computing the weighted value associated with performing the operation, such as described above with respect to FIG. 4. Referring first to FIG. 5a, the method receives as inputs a user-specified cost criterion (or criteria) and a request to perform an operation on data (e.g., a file). The user-specified cost criterion may specify whether to prioritize time or cost when computing the weighted value. For example, if the user prioritizes time, then the services are weighted according to the amount of time taken to perform the operation (historically). Likewise, if the user prioritizes cost, then the services are weighted according to the monetary cost to perform the operation (historically and/or currently, if, e.g., a price quote is obtained in response to the user request). If neither time nor cost is specified, then both parameters can be considered in the computation. The user-specified cost criterion may also include caps or limits on the time and/or monetary costs used in the computation. For example, the user may specify that monetary cost is a priority, but that services costing more than a certain dollar amount should be excluded from the computation. In other words, the caps can be used to exclude certain services from the result of the computation. Depending on the user-specified criterion, different formulae can be used to compute the weighted value, such as illustrated in FIG. 5a.

Referring now to FIG. 5b, the method receives as further inputs a user request to perform an operation on data (e.g., a file) and historical information about services capable of performing the operation from a cache, such as described above with respect to FIG. 4. If the user has specified any caps on the monetary cost or time, any historical information that includes cost or time exceeding the caps can be eliminated from the computation. A weighted value for each service in the remaining historical information can then be computed using the formula determined in the portion of the method illustrated in, and described above with respect to, FIG. 5a. In some instances, the user may wish to quantify time as a monetary cost by using a time-to-cost conversion and use the conversion as a factor rather than (or in addition to) time for computing the weighted values(s). Using the computed weighted values for each service, the method continues by generating a list of the services ordered by the weighted values. The list may be ordered, for example, in ascending order (lowest weighted value listed before highest weighted value).

Example Search Result User Interface

FIG. 6 shows an example search result user interface, configured in accordance with an embodiment. The user interface is configured to display a list of one or more files, services and locations that result from a search query. The list shows various information, such as file name, file size, and date, which is retrieved from a local cache, such as described above with respect to FIG. 3. The list can also include icons or other indications of the location of the respective file. In the example of FIG. 6, two cloud-shaped icons are used to indicate that the respective files are stored in the cloud, while the lack of such icons may indicate that the other two files are stored locally or in a location outside the cloud. Further, in this example, three of the files have the same name, but have different dates and/or storage locations. The items in the list can be ordered by a weighted value computed based on historical information in the cache, such as in a manner described above with respect to FIGS. 5a and 5b. Through the user interface, a user can select one or more of the listed files and perform an operation (e.g., copy, delete, move, etc.) on the selected files using a service meeting the specified cost criterion, such as lowest monetary cost or fastest processing time.

Numerous embodiments will be apparent in light of the present disclosure, and features described herein can be combined in any number of configurations. One example embodiment provides a computer-implemented method. The method includes receiving, via a user interface, a user request to perform an operation on a file, retrieving, from a cache, historical information about each of a plurality of services capable of performing the operation, the historical information including at least one of a monetary cost of performing the operation and an amount of time to perform the operation, computing, for each service, a weighted value associated with performing the operation based on the historical information, an age of the historical information, and a user-specified cost criterion, and generating a list of the services indicating the weighted value of each service. In some cases, the user-specified cost criterion represents a relative importance of the monetary cost of performing the operation with respect to the amount of time to perform the operation, and the method further includes adjusting the weighted value based on the relative importance. In some cases, the user-specified cost criterion represents at least one of a maximum value of the monetary cost of performing the operation and a maximum amount of the time to perform the operation, and the weighted value is computed based on a portion of the historical information for which the user-specified cost criterion is satisfied. In some cases, the method further includes displaying the list of the services via the user interface. In some such cases, the method further includes receiving a user selection of one of the services via the user interface, and sending a request to the user-selected service to perform the operation. In some such specific cases, the method further includes refreshing the historical information in the cache based on the user-selected service. In some such specific cases, the method further includes repeating the computing of the weighted value and generating the list of services based the refreshed historical information. In some cases, the method includes weighting the age of the historical information about one of the services based on a prior user selection of the respective service and/or a measured outcome of a prior performance of the operation by the respective service. In some cases, the method further includes classifying each service as one of a data storage service and an application service, where the weighted value is further computed with respect to the classification of each service.

Another example embodiment provides a storage and a processor operatively coupled to the storage. The processor is configured to receive, via a user interface, a user request to perform an operation on a file and retrieve, from a cache, historical information about each of a plurality of services capable of performing the operation, the historical information including a monetary cost of performing the operation and/or an amount of time to perform the operation. The processor is further configured to compute, for each service, a weighted value associated with performing the operation based on the historical information, an age of the historical information, and a user-specified cost criterion, and generate a list of the services indicating the weighted value of each service. In some cases, the user-specified cost criterion represents a relative importance of the monetary cost of performing the operation with respect to the amount of time to perform the operation, and the processor is further configured to adjust the weighted value based on the relative importance. In some cases, the user-specified cost criterion represents a maximum value of the monetary cost of performing the operation and/or a maximum amount of the time to perform the operation, and the weighted value is computed based on a portion of the historical information for which the user-specified cost criterion is satisfied. In some cases, the user interface is operatively connected to the processor, and the processor is further configured to display the list of the services via the user interface. In some such cases, the processor is further configured to receive a user selection of one of the services via the user interface, and send a request to the user-selected service to perform the operation. In some such specific cases, the processor is further configured to refresh the historical information in the cache based on the user-selected service. In some such specific cases, the processor is further configured to repeat the computing of the weighted value and generating the list of services based the refreshed historical information. In some cases, the processor is further configured to weight the age of the historical information about one of the services based on a prior user selection of the respective service and/or a measured outcome of a prior performance of the operation by the respective service. In some cases, the processor is further configured to classify each service as one of a data storage service and an application service, and the weighted value is further computed with respect to the classification of each service. In some cases, some or all of the functions variously described in this paragraph can be performed in any order and at any time by one or more different user computing systems, some or all of which are operatively coupled to the cloud. Another example embodiment provides a non-transient computer-readable medium or computer program product having instructions encoded thereon that when executed by one or more processors cause the processor(s) to perform one or more of the functions variously described in this paragraph.

The foregoing description and drawings of various embodiments are presented by way of example only. These examples are not intended to be exhaustive or to limit the invention to the precise forms disclosed. Numerous variations will be apparent in light of this disclosure. Alterations, modifications, and variations will readily occur to those skilled in the art and are intended to be within the scope of the invention as set forth in the claims.

What is claimed is:

1. A computer-implemented method comprising:
receiving, via a user interface, a user request to perform an operation on a file;
retrieving, from a cache, historical information about each of a plurality of services capable of performing the operation, the historical information including at least one of a monetary cost of performing the operation and an amount of time to perform the operation;
computing, for each service, a weighted value associated with performing the operation based on the historical information, an age of the historical information, and a user-specified cost criterion; and
generating a list of the services indicating the weighted value of each service.

2. The method of claim 1, wherein the user-specified cost criterion represents a relative importance of the monetary cost of performing the operation with respect to the amount of time to perform the operation, and wherein the method further comprises adjusting the weighted value based on the relative importance.

3. The method of claim 1, wherein the user-specified cost criterion represents at least one of a maximum value of the monetary cost of performing the operation and a maximum amount of the time to perform the operation, and wherein the weighted value is computed based on a portion of the historical information for which the user-specified cost criterion is satisfied.

4. The method of claim 1, further comprising displaying the list of the services via the user interface.

5. The method of claim 4, further comprising receiving a user selection of one of the services via the user interface, and sending a request to the user-selected service to perform the operation.

6. The method of claim 5, further comprising refreshing the historical information in the cache based on the user-selected service.

7. The method of claim 6, further comprising repeating the computing of the weighted value and generating the list of services based the refreshed historical information.

8. The method of claim 1, further comprising weighting the age of the historical information about one of the services based on at least one of a prior user selection of the respective service and a measured outcome of a prior performance of the operation by the respective service.

9. The method of claim 1, further comprising classifying each service as one of a data storage service and an application service, wherein the weighted value is further computed with respect to the classification of each service.

10. A system, comprising:
a storage; and
a processor operatively coupled to the storage and configured to:
receive, via a user interface, a user request to perform an operation on a file;
retrieve, from a cache, historical information about each of a plurality of services capable of performing the operation, the historical information including at least one of a monetary cost of performing the operation and an amount of time to perform the operation;
compute, for each service, a weighted value associated with performing the operation based on the historical information, an age of the historical information, and a user-specified cost criterion; and
generate a list of the services indicating the weighted value of each service.

11. The system of claim 10, wherein the user-specified cost criterion represents a relative importance of the monetary cost of performing the operation with respect to the amount of time to perform the operation, and wherein the processor is further configured to adjust the weighted value based on the relative importance.

12. The system of claim 10, wherein the user-specified cost criterion represents at least one of a maximum value of the monetary cost of performing the operation and a maximum amount of the time to perform the operation, and wherein the weighted value is computed based on a portion of the historical information for which the user-specified cost criterion is satisfied.

13. The system of claim 10, wherein the user interface is operatively connected to the processor, and wherein the processor is further configured to display the list of the services via the user interface.

14. The system of claim 13, wherein the processor is further configured to receive a user selection of one of the services via the user interface, and send a request to the user-selected service to perform the operation.

15. The system of claim 14, wherein the processor is further configured to refresh the historical information in the cache based on the user-selected service.

16. The system of claim 15, wherein the processor is further configured to repeat the computing of the weighted value and generating the list of services based the refreshed historical information.

17. The system of claim 10, wherein the processor is further configured to weight the age of the historical information about one of the services based on at least one of a prior user selection of the respective service and a measured outcome of a prior performance of the operation by the respective service.

18. The system of claim 10, wherein the processor is further configured to classify each service as one of a data storage service and an application service, wherein the weighted value is further computed with respect to the classification of each service.

19. A non-transient computer program product having instructions encoded thereon that when executed by one or more processors cause a process to be carried out, the process comprising:
receive, via a user interface, a user request to perform an operation on a file;
retrieve, from a cache, historical information about each of a plurality of services capable of performing the operation, the historical information including at least one of a monetary cost of performing the operation and an amount of time to perform the operation;
compute, for each service, a weighted value associated with performing the operation based on the historical information, an age of the historical information, and a user-specified cost criterion; and
generate a list of the services indicating the weighted value of each service.

20. The non-transient computer-readable medium of claim 19, wherein the user-specified cost criterion represents a relative importance of the monetary cost of performing the operation with respect to the amount of time to perform the operation, and wherein the computer-readable medium has further instructions encoded thereon that when executed by the processor cause the processor to adjust the weighted value based on the relative importance.
